(19) United States
(12) Patent Application Publication
(10) Pub. No.: US 2002/0133427 A1
(43) Pub. Date: Sep. 19, 2002

(54) Real estate business support system and method

(75) Inventor: Taiho Shu, Chiba (JP)

Correspondence Address: OLIFF & BERRIDGE, PLC, P.O. BOX 19928, ALEXANDRIA, VA, 22320, US

(73) Assignee: FEALS, Incorporated Company, Tokyo (JP)

(21) Appl. No.: 10/133,474

(22) Filed: Apr. 29, 2002

Related U.S. Application Data
(63) Continuation of application No. PCT/JP00/06201, filed on Sep. 12, 2000.

(30) Foreign Application Priority Data
Nov. 15, 1999 (JP) 11-323606

(51) Int. Cl. G06F 17/60

(52) U.S. Cl. 705/26

(57) ABSTRACT

A real estate business support system for realizing efficient business when a franchise system of real estate agencies is developed comprises an information providing terminal which is provided in an alliance agency, enables retrieval of real estate property information, and is capable of outputting a property slip which includes identification information of the alliance agency and real estate property information, a system center server, and a contractor agency computer which is provided in a contractor agency, enables input of identification information of the alliance agency, client information, and the real estate property information, is capable of sending identification information of the alliance agency, the client information and the real estate property information to the system center server, and receives contract data from the system center server to print the data. The system center server associates identification information of the alliance agency, identification information of the real estate property, identification information of the contractor agency which attended a client, and identification information of the real estate dealing with one another, stores such information into a storage device, allocates a predetermined commission to the alliance agency and the contractor agency associated with the identification information about the real estate dealing when payment related to the contract by the client was inputted.

### CROSS-REFERENCE TO RELATED APPLICATIONS

This is a continuation of International Application PCT/JP00/06201, filed Sep. 12, 2000, now abandoned.

### TECHNICAL FIELD OF THE INVENTION

This invention relates to a real estate business support system, and more particularly to a real estate business support system to be used when a franchise system of real estate agencies is developed.

### BACKGROUND OF THE INVENTION

Conventionally, a computer system used for real estate business was composed of a host computer which accumulated information of real estate properties collected by each agency and a plurality of information search terminals online connected with this host computer and installed in real estate agencies and the like. And then, a client used to acquire information of real estate properties, which satisfied his or her desired conditions, by inputting his or her desired conditions to the information search terminal and searching the information with his or her desired conditions, and, if necessary, to communicate with a staff member stationed at the agency. Then, if he or she made a contact, he or she used to sign and to seal a contract prepared by the staff member, and to make contract payment in the agency.

In addition, by recent popularization of the Internet, Web sites, which accumulate a lot of information as to real estate properties and enable their clients to search the information of real estate properties, come out, but not so many Web sites can not provide their clients with services which are more than information providing.

At each real estate agency which uses such a conventional technique, collection and advertisements of real estate property information, introducing real estate properties to clients, preparing and managing contracts, settlement of contract payment, and, in a case where a real estate property is a leased property, contract renewal procedures and move-out management and the like used to be done by employing necessary staff members. This costs personnel expenses and is not efficient. In addition, there is a limit to an ability to collect clients if an independent agency does by itself.

### SUMMARY OF THE INVENTION

Therefore, an object of this invention is to provide a real estate business support system to increase the efficiency of works in each agency when a franchise system of real estate agencies is developed, and computers which are necessary for this system.

In addition, another object of this invention is to provide a real estate business system to improve an ability of each real estate agency to collect clients and to feed back contributions to collecting clients, and computers, which are necessary for this system.

Furthermore, another object of this invention is to provide a program to be executed on this real estate business support computer.

A real estate business support system according to the first aspect of this invention comprises an information providing terminal which is installed in an alliance agency, enables retrieval of real estate property information, and is capable of outputting a property slip including identification information of the alliance agency (this identification information may include identification information of the information providing terminal.) and information as to a selected real estate property; at least one server installed in a system center; and at least one contractor agency computer which is installed in a contractor agency and is capable of inputting and sending identification information of the alliance agency, client information, and identification information of a real estate property to the server installed in the system center. In addition, at least one server installed in the system center associates the identification information of the alliance agency, the identification information of the real estate property, identification information of the contractor agency where a contractor agency computer, from which the identification information of the real estate property for the client was sent, is installed, and identification information of a real estate dealing with one another, stores such information into a storage device, and performs allocation of a predetermined commission to the alliance agency and the contractor agency associated with the identification information of the real estate dealing if payment related to a contract from the client was inputted. Introducing the information providing terminal improves the ability to collect clients of the contractor agency. In addition, the alliance agency gets fed back for its contribution to collect clients by allocating the predetermined commission. Since this allocation of the predetermined commission to the alliance agency is performed by the server installed in the system center, it can promote business efficiency of each contractor agency to improve.

The aforementioned information providing terminal may comprise a telephone function to telephone a call center in the system center. And, the real estate business support system according to the first aspect of this invention may further comprise a call center terminal installed in the call center, for inputting client information, and for storing into a server storage installed in the system center, the client information, identification information of an alliance agency in which the information providing terminal being used by the client is installed, identification information of a contractor agency introduced to the client.

In addition, the server installed in the system center may send information as to a prospective client to the contractor agency introduced to the client.

In addition, the real estate business support system according to the first aspect of this invention may further comprise a contractor agency server, which is installed in the contractor agency and enables search of real estate property information received through satellite communications from the system center. Using satellite communications enables to distribute data at high speed and over the large area. Since the search speed becomes higher by storing the data in the contractor agency server, the client can get greater satisfaction.

Incidentally, real estate property information to be stored in the contractor agency server may be limited to information as to real estate properties within a predetermined area, and the contractor agency server may enable search of information as to real estate properties outside the predetermined area by acquiring such information online from the server, which is installed in the system center and stores real estate property information. It gives consideration to a storage capacity of the contract agency server. For example, this configuration enables to cope with even if a client searches properties in his or her new post in the distance.

In addition, the aforementioned server, which is installed in the system center, may perform a processing to prepare a notice of renewing the contract for the client. It can promote business efficiency of each contractor agency to improve.

The real estate business support system according to the first aspect of this invention may further comprise means for performing a processing to distribute real estate property information to be searched by the client through satellite communications.

Furthermore, the aforementioned contractor agency computer may be capable of receiving and printing out data of a contract for the client and a real estate property from the server installed in the system center. And, the aforementioned server installed in the system center may further comprise means for generating and sending the data of the contract for the client and the real estate property to the contractor agency, which requested the data of the contract. Since it can save each contractor agency from managing contracts, it promotes business efficiency of each contractor agency to improve more.

A real estate business support system according to the second aspect of this invention comprises at least one server installed in the system center; and at least one contractor agency computer which is installed in a contractor agency, enables search of real estate property information, and is capable of inputting and sending client information and identification information of the real estate property to the server installed in the system center, and receiving and printing out data of a contract for the client and the real estate property from the server installed in the system center. In addition, at least one server installed in the system center associates the identification information of the real estate property, identification information of the contractor agency where a contractor agency computer, from which the identification information of the real estate property for the client was sent, is installed, and identification information of a real estate dealing with one another, stores such information into a storage device, generates and sends the data of the contract for the client and the real estate property to the contractor agency which requested the data of the contract, and performs allocation of a predetermined commission to the contractor agency associated with the identification information of the real estate dealing if payment related to the contract from the client was inputted. It can promote business efficiency of each contractor agency to improve.

A real estate business support computer to be installed in the system center according to the third aspect of this invention comprises means for associating and storing into a storage device, client information as to a client who used an information providing terminal which is installed in an alliance agency, enables search of real estate property information, and is capable of outputting a property slip which includes identification information of the alliance agency and information as to a selected real estate property, identification information of the alliance agency where the client visited, identification information of a real estate property, identification information of a contractor agency which attended the client, and identification information of a real estate dealing with one another; and means for performing allocation of a predetermined commission to the alliance agency and the contractor agency associated with the identification information of the real estate dealing if payment related to a contract from the client was inputted.

The real estate business support computer according to the third aspect of this invention may further comprise means for generating and sending to a contractor agency computer installed in the contractor agency which attended the client, data of a contract for the real estate dealing, in response to a request from the contractor agency computer.

A real estate business support method according to the fourth aspect of this invention comprises the steps of: accepting client information as to a client who used an information providing terminal which is installed in an alliance agency, enables search of real estate property information, and is capable of outputting a property slip which includes identification information of the alliance agency and information as to a selected real estate property; accepting the identification information of the alliance agency where the client visited; accepting identification information of a contractor agency which attends the client; accepting the identification information of the real estate property; associating and storing into a storage device, the identification information of the alliance agency, the identification information of the contractor agency, the identification information of the real estate property, and identification information of a real estate dealing with one another; and performing allocation of a predetermined commission to the alliance agency and the contractor agency associated with the identification information of the real estate dealing if payment related to a contract from the client was inputted.

Incidentally, the real estate business support method according to the fourth of this invention, may further comprise a step of generating and sending t o a contractor agency computer installed in the contractor agency which attended the client, data of a contract for the real estate dealing, in response to a request from the contractor agency computer.

A program which cause a computer to execute the aforementioned real estate business support method according to the fourth aspect of this invention can be created, and the program is stored in a storage medium or a storage device such as a floppy disk, a CD-ROM, a magneto-optical disk, a semiconductor memory, a hard disk.

### BRIEF DESCRIPTION OF THE DRAWING

FIG. 1 is a block diagram showing the outline of apparatuses in an embodiment of this invention;

FIG. 2 is a diagram showing a processing flow in a second preferred embodiment of this invention; and

FIG. 3 is a diagram showing a processing flow in a third preferred embodiment of this invention.

### DETAIL DESCRIPTION OF THE PREFERRED EMBODIMENTS

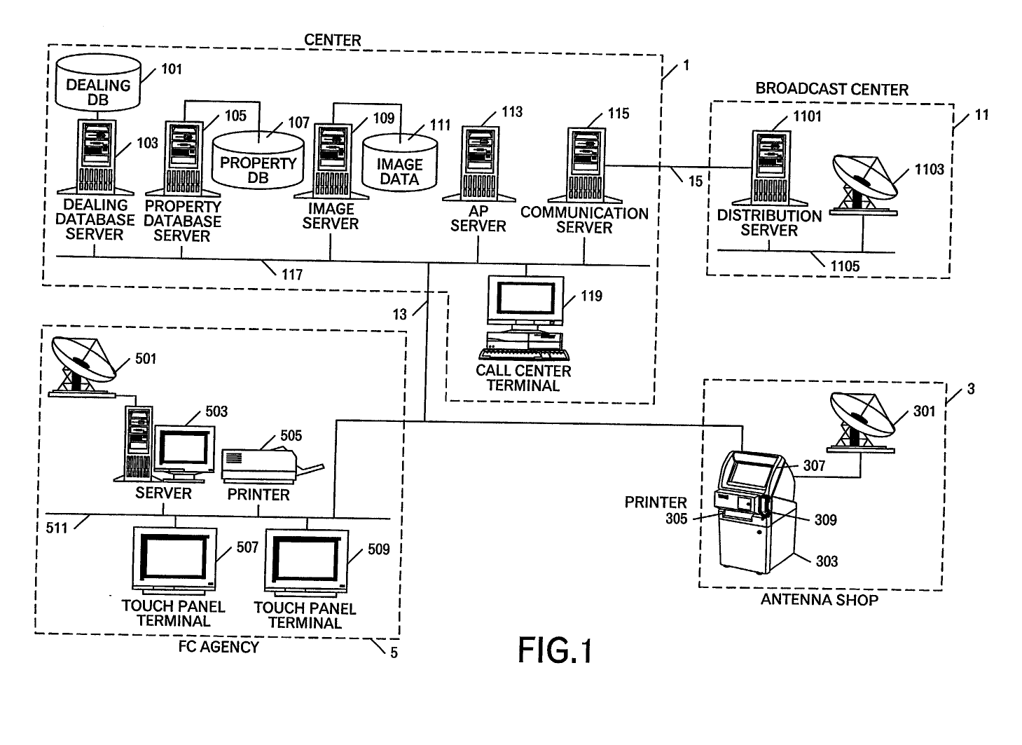

A system outline figure for one preferred embodiment of this invention is shown in FIG. 1. FIG. 1 shows a center 1 which is a franchiser, an FC agency 5 that is a franchisee, an antenna shop 3 that is an alliance agency, and a broadcast center 11. Although FIG. 1 shows only one FC agency 5 which is the franchisee, there are usually many FC agencies 5. Likewise, although FIG. 1 shows only one antenna shop 3, there are usually many antenna shops 3. Incidentally, although there is usually one center 1 which is the franchiser, the system itself may be provided separately over a plurality of places. In addition, the center 1 may open its direct management agencies, and the direct management agencies and the FC agency 5 may carry out almost the same business. However, the direct management agencies may carry out other business, in addition to business of the FC agency 5. Accordingly, these may have additional functions also in a system. In a case of real estate business associated with this preferred embodiment, for example, the direct management agencies are to carry out business such as getting new real estate properties. Accordingly, the direct management agencies are required to change in the system configuration such as to add a terminal for registering the new real estate properties. However, such a configuration of direct management agencies is not directly related to the substance of this invention, so any further explanation is omitted.

In this preferred embodiment, the FC agencies 5 can be opened dispersedly over areas where real estate properties can be gotten. If real estate properties can be gotten in the whole country, the FC agencies 5 can be opened dispersedly in the whole country. Meanwhile, since it is necessary to guide clients to the FC agencies 5, the antenna shops 3 which are the alliance agencies cannot exist unrelated to locations of the FC agencies 5. Incidentally, the broadcast center 11 is an organization, which performs data broadcasting by using a broadcast satellite, which is not shown.

The center 1 has, for example, a dealing database server 103 which is connected with a dealing database 101 which stores dealing information and manages the dealing database 101, a property database server 105 which is connected with a property database 107 which stores information of real estate properties and manages the property database 107, an image server 109 which is connected with an image data storage 111 which stores image data of real estate properties and manages the image data storage 111, an AP (Application Program) server 113 which executes an application program for this invention, and a communication server 115 for sending data to be distributed through the satellite communication to the broadcast center 11, and these servers are connected with each other through the local area network (LAN) 117. The LAN 117 can be connected with other computers. In addition, a call center, which answers inquiries and the like from clients, may be established in the center 1, and this call center has a call center terminal 119. Although FIG. 1 shows only one call center terminal 119, there can be a plurality of call center terminals 119. Incidentally, since the call center terminal 119 may also refer to dealing information and/or real estate property information, it is connected with the LAN 117. Incidentally, the call center may be established distantly from the center 1, so the call center terminals 119 may be connected with the LAN 117 via some communication lines.

The broadcast center 11 has a distribution server 1101 connected with the communication server 115 in the center 1 through the communication line 15 and an antenna 1103 for communicating with a satellite, which is not shown. This distribution server 1101 and the antenna 1103 are connected with one another, for example, through the network 1105. This distribution server 1101 is a server for managing data to be sent to the satellite from the antenna 1103.

The FC agency 5 has an FC agency server 503 which stores information as to real estate properties in an area of which the FC agency 5 takes charge and other necessary data, a printer 505, and touch panel terminals 507 and 509, and these are connected with each other through the LAN 511. In addition, for example, the FC agency server 503 is connected with an antenna 501. Incidentally, although FIG. 1 shows two touch panel terminals 507 and 509, these are not limited to two in this preferred embodiment. In addition, LAN 511 can be connected with other computers. Although non-touch panel terminals can be installed instead of touch panel terminals 507 and 509, terminals which clients operate are touch panel type here from the viewpoint of the usability.

The antenna shop 3 has an information providing terminal 303. This information providing terminal 303 has a touch panel display device 307 which a client operates when he or she searches real estate property information, a printer 305 which is capable of printing out real estate property information which the client wants, a receiver 309 for telephoning the call center provided in the center 1, and a communication function, which is not shown, including a telephone function. In this preferred embodiment, information as to real estate properties in an area of which the antenna shop 3 takes charge may be stored in the information providing terminal 303, or the information providing terminal 303 may receive information from a server in the center 1 whenever the client searches. If the information as to the real estate properties in the area of which the antenna shop 3 takes charges is stored in the information providing terminal 303, the information providing terminal 303 has a storage device and is connected with the antenna 301.

The LAN 117 in the center 1 and the LAN 511 in the FC agency 5 are connected with one another through some communication means 13. This communication means 13 may be, for example, a private line or a communication line of CATV for broadcasting programs. In addition, the information providing terminal 303 in the antenna shop 3 and the LAN 117 in the center 1 may be connected with one another through the communication means 13. If the telephone function of the information providing terminal 303 is realized, for example, by using a technique of an internet-phone, the communication means 13 is to be realized by the private line or the Internet. If the telephone function is the same as a function of a usual telephone, the information providing terminal 303 is to be connected with the call center in the center 1 via the public network.

First, the center 1 collects information of real estate properties, and inputs predetermined information and image data as to each real estate property by a computer, which is connected with the LAN 117 and is not shown. This predetermined information as to each real estate property is, for example, the layout of the rooms, a nearest station, the traffic means and necessary time from the nearest station, the amount of money, the years elapsed from the construction, an address, attached equipment and so on. The image data includes, for example, digital image data of the exterior, kitchen, living and the like, which is photographed from predetermined places. The inputted information as to each real estate properties is stored into the property database 107 by the property database server 105. In addition, the image data is stored into the image data storage 111 by the image server 109.

Since a lot of image data is registered for every real estate property, if the FC agency server 503 in the FC agency 5 or the information providing terminal 303 in the antenna shop 3 obtains the information as to the real estate property via the communication means 13 from the image data storage 111 at searching, it is likely to delay a response to the user. Therefore, at least a portion of necessary information is to be locally stored in this system. Namely, information, which includes image data, as to real estate properties in the area of which the FC agency 5 and the antenna shop 3 take charge is to be stored in the FC agency server 503 in the FC agency 5 and the information providing terminal 303 in the antenna shop 3 in advance. However, since the antenna shop 3 is required to have the antenna 301 to locally store the information as to the real estate properties, according to circumstances, it may request necessary information at searching through the communication means 13 to the property database server 105 and the image server 109 in the center 1. Hereinafter, it will be explained on the assumption that the antenna shop 3 has the antenna 301.

The center 1 uses the broadcast center 11 to send update data efficiently everyday to the FC agency server 503 in the FC agency 5 and the information providing terminal 303 in the antenna shop 3. Concretely, the communication sever 115 reads out update data up to the previous day from the property database 107 managed by the property database server 105 and the image data storage 111 managed by the image server 109 and sends the update data to the distribution server 1101 through the communication line 15. Incidentally, although the communication line 15 is shown clearly in FIG. 1, it is also possible that communication server 115 generates data to be distributed and the data is inputted offline to the distribution server 1101 in the broadcast center 11.

The distribution server 1101, which received the data to be distributed via the communication line 15 or accepted input data offline, sends the data to be distributed via the antenna 1103 to the satellite, which is not shown. The satellite broadcasts the data from the antenna 1103 to the broadcast areas. At this time, the receiving control is performed by using a key and the like to prevent ones, which are neither the FC agency 5 nor the antenna shop 3 from using the received data.

For data received via the antenna 501 in the FC agency 5 and antenna 301 in the antenna shop 3, the FC agency server 503 and the information providing terminal 303 perform a processing to store only information as to the area of which the FC agency 5 and the antenna shop 3 take charge. It is to increase the efficiency of search and a storage capacity. If a client searches real estate properties in an area far from the FC agency 5 and the antenna shop 3, for example, because he or she is going to move into his or her new post and so on, the touch panel terminal 507 or 509 and the information providing terminal 303 is to directly obtain the data via the communication means 13 from the property database 107 and the image data storage 111 in the center 1. The FC agency server 503 has a database server function to accept inputs of search condition from the touch panel terminal 507 or 509 and to send back a result of the search to the touch panel terminal from which the search condition was inputted.

The aforementioned processings enable the client to search a desired real estate property with the touch panel terminal 507 or 509 in the FC agency 5 and with the information providing terminal 303 in the antenna shop 3.

### 1. First Preferred Embodiment

Next, processings in a case where a client directly comes to the FC shop agency 5 are explained. Incidentally, it is explained with an example of a case where a real estate property is a property for renal, in a following explanation. The client goes to the FC agency 5, and searches a desired real estate property, by operating the touch panel terminal 507 or 509. If necessary, the client can obtain printed matter of necessary information as to the real estate property from the printer 505, by instructing to print out from the touch panel terminal 507 or 509. In addition, if the client wants to take more detailed explanation, he or she consults a staff member of the FC agency 5. At this point, the client performs client registration. For example, a name, a present address, an office name or a school name, an office address or a school address, an age, gender, are registered. The staff member of the FC agency 5 registers such client information for a pre-contracting client, by using the touch panel terminal 507 or 509, or terminals and the like which are not shown. For example, database of “a visitor card” is provided and data as to the pre-contracting clients is registered in that. Incidentally, this data as to the pre-contracting clients may be stored in the FC agency server 503, or may be included in the dealing database 101 managed by the dealing database server 103 in the center 1.

If the client wants to make a contract for the real estate property, the staff member of the FC agency 5 registers relevant information to the dealing database 101. On this occasion, at least identification information of the FC agency 5, which deals with the contract, identification information of this real estate dealing, identification information of the property, and client information are associated with each other and stored into the dealing database 101. More concretely, an identification number of the FC agency 5 which deals with the contract, a dealing number, a property number, and a name and an address of the property, client information and the like are registered to a dealing register of the dealing number in the dealing database 101. Incidentally, since the client information was registered before, the client information is to be read out and used. For registration, information to be registered to the dealing register is sent via the communication means 13 from a terminal in the FC agency 5 to the dealing database server 103. If dealing registers are managed in advance for each FC agency 5 and information as to the pre-contracting clients is, for example, included in the dealing database 101, information to be sent from the FC agency 5 is only information which identifies the client and the identification information of the real estate property, which is subject to the contract.

When a dealing register is registered to the dealing database 101 by the dealing database server 103, for example, the dealing database server 103 generates data of a contract for the real estate property and the client, and sends the data via the communication means 13 to the FC agency server 503. The contract data is generated by embedding the client information and the like into the predetermined contract data, for example. The FC agency server 503 has the printer 505 print out the received contract data. A staff member of the FC agency 5 explains to the client based on this printed contract.

The client is only explained about the contract and subsequent procedures in the FC agency 5. The client brings back, signs and seals the contract, and then, he or she sends the contract to the center 1 by post. On this occasion, also necessary accompanying documents are sent. In addition, the client pays necessary money for the contract into an account, which the center 1 designated, through the wire transfer.

The center 1 receives a notice for receipt of money from a bank, and inputs the receipt of money from the client to the system. This receipt of money is registered to the dealing register as well. If the receipt of money is confirmed, procedures such as ones that the FC agency 5 hands or the center 1 sends by post to the client, a key of the real estate property, are to be performed.

Incidentally, if the money is received, a commission is paid to the FC agency 5 from the center 1. More particularly, the amount of money at a predetermined rate among a commission, which the center 1 received, is allocated to the FC agency 5, and the amount of money reduced by predetermined royalties to a franchiser is paid to the FC agency 5, for example, once a month. Since an identification number of an FC agency 5 which dealt with a contract and a dealing number are associated with one another in a dealing register, if the receipt of money which identifies the dealing number is performed, or if the receipt of money is inputted to the dealing register, the allocation of the commission to the FC agency 5 which deals with the contract can be performed easily. For example, the AP server 113 performs a processing for allocating the commission to the FC agency 5.

Incidentally, in a case of a leased property, a dealing register is used also at the contract renewal. For example, the AP server 113 finds out past dealings, which became within a predetermined time to the contract renewal, and prepares a notice for the contract renewal, according to information of that dealing register. In this case, it is necessary to input a date of starting a contract to this dealing register.

In a case of the contract renewal, since a client transfers a contract renewal fee to a bank account, which the center 1 designated, also this receipt of money is recorded into the dealing register. Also as for this contract renewal fee, the amount of money at a predetermined rate is allocated to an FC agency 5 which dealt with the contract when the contract was made. Since an identification number of the FC agency 5 which dealt with the contract and a dealing number are associated with one another in the dealing register, if the receipt of money is recorded into the dealing register, the allocation of a commission to the FC agency 5 which dealt with the contract can be performed easily. For example, the AP server 113 performs a processing for allocating the commission to the FC agency 5.

Terminals and servers installed in the center 1, the antenna shops 3, and the FC agencies 5 are programmed to perform the aforementioned processings.

### 2. Second Preferred Embodiment

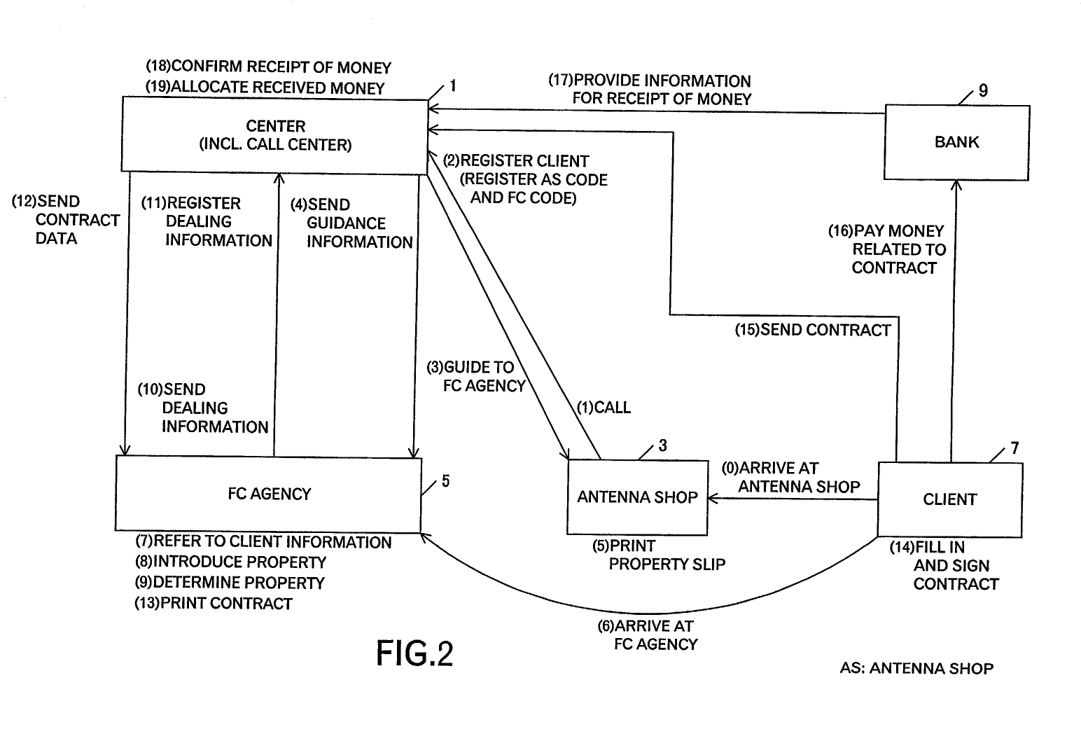

Next, a first processing flow of a whole system in a case where a client comes to the antenna shop 3 first is explained with FIG. 2.

A client 7 goes to, for example, a drug store, which is an antenna shop 3 (Step (0)) . The client 7 searches a desired real estate property, by operating the information providing terminal 303 installed in this antenna shop 3. If the client 7 found a real estate property which suits his or her desired conditions, or if he or she wants to inquire about contents of a real estate property and so on, he or she telephones the call center with a receiver 309 (Step (1)) . An operator at the call center in the center 1 operates a call center terminal 119, obtains client information in conversation with the client 7, and registers the client information (Step (2)) . In this preferred embodiment, if the client 7 calls from the information providing terminal 303, identification information, which is an “AS code” in FIG. 2, of the antenna shop 3, in which the information providing terminal 303 is installed, is registered with the client information to be inputted by the operator at the call center. When registering, a computer in the center 1 receives the data to be registered.

In addition, the call center terminal 119 searches and displays information as to an FC agency 5 which takes charge of that area, according to the AS code of the antenna shop 3. The operator at the call center guides the client 7 to the FC agency 5 (Step (3)) . In this preferred embodiment, also the identification information, which is an FC code in FIG. 2, of the FC agency 5 where the operator at the call center guided the client 7 is registered with the client information. If there are a plurality of FC agencies 5 which take charge of the antenna shop 3, the operator guides the client 7 to an FC agency 5 which he or she selected, and registers identification information of the selected FC agency with the client information. The registered information is stored, for example, in a potion of the dealing database 101.

Thus, the client information, identification information of the antenna shop 3 where the client 7 visited, identification information of the FC agency 5 where the operator at the call center guided the client 7 are registered, and then, for example, the client information as to the client 7 whom the operator at the call center guided is sent as guidance information from the dealing database server 103 to an FC agency server 503 in this registered FC agency 5 (Step (4)) . The guidance information may include the identification information of the antenna shop 3 where the client 7 visited.

The client 7 prints out a property slip which includes information as to a real estate property which suits his or her desired conditions by a printer 305 in the information providing terminal 303 (Step (5)) . The proper slip includes not only information as to the real estate property but also the identification number of the antenna shop 3 in which the information providing terminal 303 is installed. Incidentally, since a plurality of information providing terminals 303 may be installed in the antenna shop 3, not the identification information of the antenna shop 3 itself but identification information of the information providing terminal 303 may be printed out onto the property slip. However, since the identification information of the information providing terminal 303 and the identification information of the antenna shop 3 can be associated with one another, if only the identification information of the information providing terminal 303 is printed out on the property slip, the antenna shop 3 can be identified later. In a following explanation, the identification information of the information providing terminal 303 and identification information of the antenna shop 3 are equated.

Next, the client 7 visits the FC agency 5 where the operator at the call center guided him or her, bringing the property slip which he or she obtained in the antenna shop 3 (Step (6)) . A staff member of the FC agency 5 searches this client 7, who came to this FC agency, from the guidance information, which is stored in the FC agency server 503 and sent from the center 1, and the pre-contracting registered clients. For example, Japanese characters for pronouncing Chinese characters of a name of the client 7 are used for this search. If it is be confirmed that the client 7 has the property slip, it is possible to extract client information as to the client 7, who came to this FC agency 5, from the guidance information (Step (7)) . Thus, since the client registration was performed once, re-registration of the client is not required in the FC agency 5. After this, the staff member of the FC agency 5 introduces the real estate property to the client 7 (Step (8)) , and the client 7 determines to make a contract (Step (9)) .

If the client 7 determines to make a contract, the staff member of the FC agency 5 inputs information to be registered to a dealing register and sends the information to the dealing database server 103 in the center 1 (Step (10)) . When the dealing database server 103 receives the information, it generates and registers a dealing register of the real estate dealing into the dealing database 101 (Step (11)) . On this occasion, identification information of the FC agency which deals with the contract, the identification information of the antenna shop 3 which contributed to guiding the client 7 to the FC agency 5, identification information of this real estate dealing, identification information of the property, and the client information are associated with each other and stored in the dealing database 101. More concretely, identification information (i.e. an FC code) of the FC agency which deals with the contract, the identification information (i.e. an AS code) of the antenna shop 3, a dealing number, a property number, a name and an address of the property, the client information and the like are registered to the dealing register of the dealing number. Incidentally, since the client information was registered before, such information is to be read out and used. In addition, since the identification number of the antenna shop 3 which contributed to guiding the client 7 to the FC agency 5 was already registered, that information is to be read out and used. If dealing registers are managed in advance for each FC agency 5 and information as to the pre-contracting clients and the AS code are included, for example, in the dealing database 101, information to be sent from the FC agency 5 is only information which identifies the client 7 and the identification information of the real estate property.

When the dealing register is registered to the dealing database 101 by the dealing database server 103, for example, the dealing database server 103 generates data of a contract for the real estate property and the client, and sends the data via the communication means 13 to the FC agency server 503 (Step (12)). The contract data is generated by embedding the client information and the like into the predetermined contract data, for example. The FC agency server 503 has the printer 505 print out the contract data (Step (13)) . A staff member of the FC agency 5 explains to the client 7 based on this printed contract.

The client 7 is only explained about the contract and following procedures in the FC agency 5. The client 7 brings back, signs and seals this contract, and then, he or she sends the contract to the center 1 by post (Step (14) and (15)) . On this occasion, also necessary accompanying documents are sent. In addition, the client pays necessary money for the contract into an account, which the center 1 designated, through the wire transfer (Step (16)) .

The center 1 receives a notice for receipt of money from a bank (Step (17)) , and inputs the receipt of money from the client 7 to the system. This receipt of money is registered to the dealing register as well. At this point, it is checked, for example, by a program of the dealing database server 103, whether or not the amount of money, which the client 7 paid, is same as necessary amount of money (Step (18)) . If the receipt of money is confirmed, procedures such as ones that the FC agency 5 hands or the center 1 sends by post to the client 7, a key of the real estate property, are to be performed.

If the money is received, a commission is paid to the FC agency 5 and the antenna shop 3 from the center 1. More concretely, the amount of money at a predetermined rate among a commission which the center 1 received is allocated to the FC agency 5 and the antenna shop 3, and the amount of money reduced by predetermined royalties to a franchiser is paid to the FC agency 5 and the antenna shop 3, for example, once a month (Step (19)) . Since the identification number (i.e. the FC code) of the FC agency 5 which dealt with the contract, the identification number (i.e. the AS code) of the antenna Shop 3 and the dealing number are associated with one another in the dealing register, if the receipt of money which identifies the dealing number is performed, or if the receipt of money is inputted to the dealing register, the allocation of the commission to the FC agency 5 which dealt with the contract and the antenna shop 3 can be performed easily. For example, the AP server 113 performs a processing for allocating the commission to the FC agency 5 and the antenna shop 3.

Incidentally, in a case of a leased property, the dealing register is used also at the contract renewal. For example, the AP server 113 finds out past dealings, which became within a predetermined time to the contract renewal, and prepares a notice for the contract renewal, according to information of that dealing register. In this case, it is necessary to input a date of starting the contract to this dealing register.

In a case of the contract renewal, since a client transfers a contract renewal fee to a bank account, which the center 1 designated, also this receipt of money is recorded into the dealing register. Also as for this contract renewal fee, the amount of money at a predetermined rate is allocated to an FC agency 5 which dealt with the contract when the contract was made. Since the identification number of the FC agency 5 which dealt with the contract and the dealing number are associated with one another in the dealing register, if the receipt of money is recorded into the dealing register, the allocation of a commission to the FC agency 5 which dealt with the contract can be performed easily. For example, the AP server 113 performs a processing for allocating the commission to the FC agency 5.

Terminals and servers installed in the center 1, the antenna shops 3, and the FC agencies 5 are programmed to perform the aforementioned processings.

As mentioned above, when a franchise system of real estate agencies is developed, business which can be performed in the center 1 among business which was performed in each agency conventionally is concentrated into the center 1 and each agency can devote itself to attend clients, and it can promote business efficiency to improve. In addition, since antenna shops 3 enable abilities of FC agencies 5 to attract clients to increase and an identification number of an antenna shop 3 is registered for each dealing, commission income from a client can be allocated to the antenna shop 3 which contributed to guiding the client to the FC agency 5.

### 3. Third Preferred Embodiment

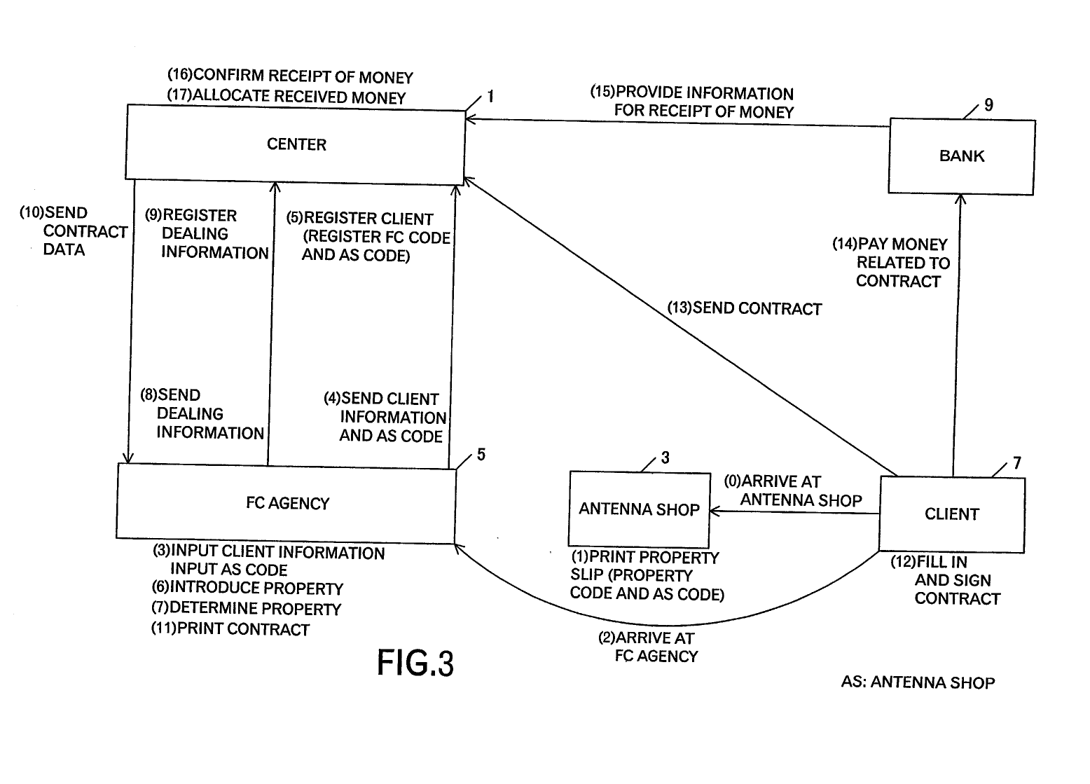

Next, a second processing flow of the whole system in a case where a client comes to the antenna shop 3 first is explained with FIG. 3.

A client 7 goes to, for example, a drug store, which is an antenna shop 3 (Step (0)) . The client 7 searches a desired real estate property, by operating an information providing terminal 303 installed in this antenna shop 3. If the client 7 found a real estate property which suits his or her desired conditions, or if he or she wants to inquire about contents of a real estate property and so on, he or she prints out that real estate property information with the printer 305 of the information providing terminal 303 (Step (1)) . Information printed out at this time is information as to contents of that real estate property, a code of that property, identification information of the antenna shop 3 in which the information providing terminal 303 used by the client 7 is installed, and so on. Although the client 7 telephoned the call center with the receiver 309 in the second preferred embodiment, he or she does not telephone in this embodiment. Incidentally, the information providing terminal 303 is configured to be capable of displaying and printing out information as to an FC agency 5 to be visited if the client 7 wants to make a contract, or if he or she wants to inquire about the contents of a real estate property and so on, so the client 7 can know about a location of this FC agency 5.

Next, the client 7 visits the FC agency 5 introduced by the information providing terminal 303, bringing the property slip which he or she obtained in the antenna shop 3 (Step (2)) . A staff member of the FC agency 5 confirms whether or not this client has already been registered. However, when it is confirmed that this client 7 is not registered, the staff member inputs client information for this client (step (3)) . Incidentally, at this time, the staff member of the FC agency 5 asks the client 7 what kind of medium is used to come to this FC agency 5. In a case where it is identified that the client 7 used the information providing terminal 5 in the antenna shop 3, the staff member inputs the identification information of the antenna shop 3. Incidentally, if the client 7 has a property slip obtained in the antenna shop 3, the staff member easily knows the identification information of the antenna shop 3. A terminal manipulated by the staff member of the FC agency 5 sends this client information and the identification information (i.e. AS code) to the dealing database server 103 (step (4)), and the dealing database server 103 registers the received information as information of a pre-contracting client into the dealing database 101 (step (5)) . On this occasion, the identification information of the FC agency 5 from which the client information and the identification information of the antenna shop 3 are sent is also registered. However, in a case where pre-contracting clients are managed for each FC agency 5, the identification information of the FC agency 5 is not apparently registered. When registering, a computer in the center 1 receives the information to be registered.

Incidentally, although information of the pre-contracting clients is registered in the center 1 in FIG. 3, it is possible to register such information in the FC agency server 503 of the FC agency 5. Accordingly, an amount of communicated data between the center 1 and the FC agency 5 can be reduced. However, since there is also a case where the center 1 would like to use the information of the pre-contracting clients, in this embodiment such information is registered in the center 1.

After this processing, the staff member of the FC agency 5 introduces the property (step (6)) , and the client 7 decides to make a contract (step (7)) .

If the client 7 decides to make a contract, the staff member of the FC agency 5 inputs information to be registered in the dealing register, and cause a computer to send the input information to the dealing database server 103 of the center 1 (step (8)) . When the dealing database server 103 receives such information, it generates a dealing register for the real estate dealing in the dealing database 101 and registers the received information (step (9)) . On this occasion, identification information of the FC agency which deals with the contract, the identification information of the antenna shop 3 which contributed to guiding the client 7 to the FC agency 5, identification information of this real estate dealing, identification information of the property, and the client information are associated with each other and stored in the dealing database 101. More concretely, identification information (i.e. an FC code) of the FC agency 5 which deals with the contract, the identification information (i.e. an AS code) of the antenna shop 3, a dealing number, a property number, a name and an address of the property, the client information and the like are registered to the dealing register of the dealing number. Incidentally, since the client information was registered before, such information is to be read out and used. In addition, since the identification number of the antenna shop 3 which contributed to guiding the client 7 to the FC agency 5 was already registered, that information is to be read out and used. If dealing registers are managed in advance for each FC agency 5 and information as to the pre-contracting clients and the AS code are included, for example, in the dealing database 101, information to be sent from the FC agency 5 is only information which identifies the client 7 and the identification information of the real estate property.

When the dealing register is registered to the dealing database 101 by the dealing database server 103, for example, the dealing database server 103 generates data of a contract for the real estate property and the client, and sends the data via the communication means 13 to the FC agency server 503 (Step (10)) . The contract data is generated by embedding the client information and the like into the predetermined contract data, for example. The FC agency server 503 has the printer 505 print out the contract data (Step (11)) . The staff member of the FC agency 5 explains to the client 7 based on this printed contract.

The client 7 is only explained about the contract and subsequent procedures in the FC agency 5. The client 7 brings back, signs and seals this contract, and then, he or she sends the contract to the center 1 by post (Step (12) and (13)) . On this occasion, also necessary accompanying documents are sent. In addition, the client pays necessary money for the contract into an account, which the center 1 designated, through the wire transfer (Step (14)) .

The center 1 receives a notice for receipt of money from a bank (Step (15)) , and inputs the receipt of money from the client 7 to the system. This receipt of money is registered to the dealing register as well. At this point, it is checked, for example, by a program of the dealing database server 103, whether or not the amount of money, which the client 7 paid, is same as necessary amount of money (Step (16)) . If the receipt of money is confirmed, procedures such as ones that the FC agency 5 hands or the center 1 sends by post to the client 7, a key of the real estate property, are to be performed.

If the money is received, a commission is paid to the FC agency 5 and the antenna shop 3 from the center 1. More concretely, the amount of money at a predetermined rate among a commission which the center 1 received is allocated to the FC agency 5 and the antenna shop 3, and the amount of money reduced by predetermined royalties to a franchiser is paid to the FC agency 5 and the antenna shop 3, for example, once a month (Step (17)) . Since the identification number (i.e. the FC code) of the FC agency 5 which dealt with the contract, the identification number (i.e. the AS code) of the antenna Shop 3 and the dealing number are associated with one another in the dealing register, if the receipt of money which identifies the dealing number is performed, or if the receipt of money is inputted to the dealing register, the allocation of the commission to the FC agency 5 which dealt with the contract and the antenna shop 3 can be performed easily. For example, the AP server 113 performs a processing for allocating the commission to the FC agency 5 and the antenna shop 3.

Incidentally, in a case of a leased property, the dealing register is used also at the contract renewal. For example, the AP server 113 finds out past dealings, which became within a predetermined time to the contract renewal, and prepares a notice for the contract renewal, according to information of that dealing register. In this case, it is necessary to input a date of starting the contract to this dealing register.

In a case of the contract renewal, since a client transfers a contract renewal fee to a bank account, which the center 1 designated, also this receipt of money is recorded into the dealing register. Also as for this contract renewal fee, the amount of money at a predetermined rate is allocated to an FC agency 5 which dealt with the contract when the contract was made. Since the identification number of the FC agency 5 which dealt with the contract and the dealing number are associated with one another in the dealing register, if the receipt of money is recorded into the dealing register, the allocation of a commission to the FC agency 5 which dealt with the contract can be performed easily. For example, the AP server 113 performs a processing for allocating the commission to the FC agency 5.

Terminals and servers installed in the center 1, the antenna shops 3, and the FC agencies 5 are programmed to perform the aforementioned processings.

As mentioned above, when a franchise system of real estate agencies is developed, business which can be performed in the center 1 among business which was performed in each agency conventionally is concentrated into the center 1 and each agency can devote itself to attend clients, and it can promote business efficiency to improve. In addition, since antenna shops 3 enable abilities of FC agencies 5 to attract clients to increase and an identification number of an antenna shop 3 is registered for each dealing, commission income from a client can be allocated to the antenna shop 3 which contributed to guiding the client to the FC agency 5.

The embodiments described above are mere examples, and various modifications are possible. For example, although the contract data is sent from the dealing database server 103 to the FC agency server 503 in the above-described embodiment, it is also possible that each FC agency server 503, for example, also stores the contract data for each real estate property, and the FC agency server 503 generates contract data to be printed and causes the printer 505 to pint out the contract data.

In addition, as described in the third preferred embodiment, any server in the center 1 or an FC agency server 503 registers information of pre-contracting clients.

Furthermore, it is possible to provide in the dealing register, a column for recording whether or not, for example, necessary documents such as the contract are received in the center 1, a column for recording whether or not a key is handed, check columns necessary for procedures when moving out, and/or columns for recording transaction of money such as refunding a deposit.

In addition, this invention can apply not only to a leased property, but also to another type of real estate properties. However, at that time, there may be no contract renewal procedure. Furthermore, applicable merchandise of this invention is not limited to a real estate property, and this invention is applicable to the sale of another merchandise, which is necessary to come to an FC agency 5.

As described above, this invention can provide a real estate business support system to increase the efficiency of works in each agency when a franchise system of real estate agencies is developed, and computers which are necessary for this system.

In addition, this invention can also provide a real estate business system to improve an ability of each real estate agency to collect clients and to feed back contributions to collecting clients, and computers and a program, which are necessary for this system.

What is claimed is:

1. A real estate business support system, comprising:
an information providing terminal, which is installed in an alliance agency, enables search of real estate property information, and is capable of outputting a property slip including identification information of said alliance agency and information concerning a selected real estate property;
at least one server installed in a system center; and
at least one contractor agency computer which is installed in a contractor agency and is capable of inputting and sending identification information of said alliance agency, client information, and identification information of a real estate property to a server installed in the system center,
wherein said at least one server installed in said system center associates and stores said identification information of said alliance agency, said identification information of said real estate property, identification information of said contractor agency where a contractor agency computer, from which said identification information of said real estate property for the client was sent, is installed, and identification information of a real estate dealing with one another, and performs allocation of a predetermined commission to said alliance agency and said contractor agency associated with said identification information of said real estate dealing if payment related to a contract from said client was inputted.

2. The real estate business support system as set forth in claim 1, wherein said information providing comprises a telephone function to telephone a call center in said system center, and further comprising a call center terminal installed in said call center, for inputting client information, and for storing into a server storage installed in said system center, said client information, identification information of an alliance agency in which an information providing terminal being used by the client is installed, identification information of a contractor agency introduced to the client.

3. The real estate business support system as set forth in claim 2, wherein said server installed in said system center sends information concerning a prospective client to said contractor agency introduced to the client.

4. The real estate business support system as set forth in claim 1, further comprising a contractor agency server which is installed in said contractor agency and enables search of real estate property information received through satellite communications from said system center.

5. The real estate business support system as set forth in claim 4, wherein said real estate property information to be stored in said contractor agency server is limited to information concerning real estate properties within a predetermined area, and said contractor agency server enables search of information concerning real estate properties outside said predetermined area by acquiring online from a server, which is installed in said system center and stores real estate property information.

6. The real estate business support system as set forth in claim 1, wherein said server installed in said system center performs a processing to prepare a notice of renewing the contract for the client.

7. The real estate business support system as set forth in claim 1, further comprising means for performing a processing to distribute real estate property information to be searched by the client via satellite communications.

8. The real estate business support system as set forth in claim 1, wherein said contractor agency computer is capable of receiving and printing out data of a contract for a client and a real estate property from said server installed in said system center, and said server installed in said system center further comprises means for generating and sending said data of said contract for said client and said real estate property to said contractor agency which requested said data of said contract.

9. A real estate business support system, comprising:
at least one server installed in a system center; and
at least one contractor agency computer which is installed in a contractor agency, enables search of real estate property information, and is capable of inputting and sending client information and identification information of the real estate property to a server installed in said system center, and receiving and printing out data of a contract for the client and the real estate property from said server installed in said system center,
wherein said at least one server installed in said system center associates and stores said identification information of said real estate property, identification information of said contractor agency where a contractor agency computer, from which said identification information of said real estate property for the client was sent, is installed, and identification information of a real estate dealing with one another, generates and sends said data of said contract for said client and said real estate property to said contractor agency which requested said data of said contract, and performs allocation of a predetermined commission to said contractor agency associated with said identification information of said real estate dealing if payment related to the contract from the client was inputted.

10. A real estate business support computer, comprising:
means for associating and storing client information concerning a client who used an information providing terminal, which is installed in an alliance agency, enables search of real estate property information, and is capable of outputting a property slip which includes identification information of said alliance agency and information concerning a selected real estate property, identification information of said alliance agency where the client visited, identification information of real estate property, identification information of a contractor agency which attended said client, and identification information of a real estate dealing with one another; and
means for performing allocation of a predetermined commission to said alliance agency and said contractor agency associated with said identification information of said real estate dealing if payment related to a contract from the client was inputted.

11. The real estate business support computer as set forth in claim 10, further comprising means for generating and sending to a contractor agency computer installed in said contractor agency which attended said client, data of a contract for said real estate dealing, in response to a request from said contractor agency computer.

12. A real estate business support method, comprising the steps of:
accepting client information concerning a client who used an information providing terminal, which is installed in an alliance agency, enables search of real estate property information, and is capable of outputting a property slip, which includes identification information of said alliance agency and information concerning a selected real estate property;
accepting said identification information of said alliance agency where said client visited;
accepting identification information of a contractor agency, which attends, said client;
accepting said identification information of said real estate property;
associating and storing said identification information of said alliance agency, said identification information of said contractor agency, said identification information of said real estate property, and identification information of a real estate dealing with one another; and
performing allocation of a predetermined commission to said alliance agency and said contractor agency associated with said identification information of said real estate dealing if payment related to a contract from said client was inputted.

13. The real estate business support method as set forth in claim 12, further comprising a step of generating and sending to a contractor agency computer installed in said contractor agency which attended said client, data of a contract for said real estate dealing, in response to a request from said contractor agency computer.

14. A program embodied on a medium for causing a computer to perform a real estate business support, said program comprising the steps of:
accepting client information concerning a client who used an information providing terminal, which is installed in an alliance agency, enables search of real estate property information, and is capable of outputting a property slip, which includes identification information of said alliance agency and information concerning a selected real estate property;
accepting said identification information of said alliance agency where said client visited;
accepting identification information of a contractor agency, which attends, said client;
accepting said identification information of said real estate property;
associating and storing said identification information of said alliance agency, said identification information of said contractor agency, said identification information of said real estate property, and identification information of a real estate dealing with one another; and
performing allocation of a predetermined commission to said alliance agency and said contractor agency associated with said identification information of said real estate dealing if payment related to a contract from said client was inputted.
